(19) United States
(12) Patent Application Publication
(10) Pub. No.: US 2019/0287191 A1
(43) Pub. Date: Sep. 19, 2019

(54) VEHICLE DETECTION AND ORDER MANAGEMENT SYSTEMS AND METHODS

(71) Applicant: Nextep Systems, Inc., Troy, MI (US)

(72) Inventor: Marshall B. CUMMINGS, Troy, MI (US)

(73) Assignee: Nextep Systems, Inc., Troy, MI (US)

(21) Appl. No.: 16/138,693

(22) Filed: Sep. 21, 2018

Related U.S. Application Data
(60) Provisional application No. 62/644,161, filed on Mar. 16, 2018.

(51) Int. Cl. G06Q 50/12; G06Q 30/06; G01S 17/02; G01S 15/04; G01V 3/10

(52) U.S. Cl. CPC G06Q 50/12; G06Q 30/0633; G01V 3/10; G01S 15/04; G01S 17/026

(57) ABSTRACT

A first vehicle detector is configured to capture first electronic vehicle signatures of vehicles at or approaching a first ordering terminal where food orders can be placed. A second vehicle detector is configured to capture second electronic vehicle signatures of vehicles at or approaching a second ordering terminal where food orders can be placed. A third vehicle detector is configured to capture third electronic vehicle signatures of vehicles at or approaching a drive-up window. Proper distribution of food orders to the appropriate vehicles is achieved at the drive-up window by matching the third electronic vehicle signatures with ones of the first and second electronic vehicle signatures.

### CROSS REFERENCE OF RELATED APPLICATION

This application claims priority to U.S. Provisional Patent Application No. 62/644,161, entitled “Integrated Vehicle-Detecting Order Management System”, filed Mar. 16, 2018, which is incorporated by reference in its entirety herein.

### FIELD

The present disclosure relates to order management systems and more particularly to systems and methods for detecting vehicles and order management.

### BACKGROUND

Many fast food restaurants include two or more drive-thru ordering stations. Multiple drive-thru ordering stations may reduce an amount of time necessary to complete a food order by allowing two or more vehicles to place orders concurrently via the two or more drive-through ordering stations.

Each of the orders, however, may be delivered to the vehicles from the same location—a drive-through window. When multiple food orders are placed within a short period of time from different drive-through ordering stations, an employee of a restaurant may not be able to determine which food order is associated with which one of the vehicles.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In a feature, an order management system is described. A first vehicle detector is configured to capture first electronic vehicle signatures of vehicles at or approaching a first ordering terminal. A second vehicle detector is configured to capture second electronic vehicle signatures of vehicles at or approaching a second ordering terminal. A drive-up window is where food orders are distributed to vehicles. A third vehicle detector is configured to capture third electronic vehicle signatures of vehicles at or approaching the drive-up window. A storage module is configured to: store one of the first electronic vehicle signatures captured via the first vehicle detector before or during placement of a first food order via the first ordering terminal; store the first food order in association with the one of the first electronic vehicle signatures; store one of the second electronic vehicle signatures captured via the second vehicle detector before or during placement of a second food order via the second ordering terminal; and store the second food order in association with the one of the second electronic vehicle signatures. A signature comparison module is configured to, in response to receipt of one of the third electronic vehicle signatures captured via the third vehicle detector: compare the one of the third electronic vehicle signatures with: (a) the stored one of the first electronic vehicle signatures; and (b) the stored one of the second electronic vehicle signatures; and select the one of (a) the stored one of the first electronic vehicle signatures and (b) the stored one of the second electronic vehicle signatures that most closely matches the one of the third electronic vehicle signatures. An order manager module is configured to: selected one of the first food order and the second food order that is associated with the selected one of (a) the stored one of the first electronic vehicle signatures and (b) the stored one of the second electronic vehicle signatures that most closely matches the one of the third electronic vehicle signatures; and output an indicator of the selected one of the first food order and the second food order.

In further features, the first, second, and third vehicle detectors include inductors.

In further features, the inductors are embedded below a driving surface over which vehicles drive.

In further features, the first, second, and third vehicle detectors include ultrasonic transceivers.

In further features, the first, second, and third vehicle detectors include infrared (IR) transceivers.

In further features, the first vehicle detector includes: a receiver; a signature module configured to capture a baseline of an output of the receiver when zero vehicles are present within a predetermined distance of the first vehicle detector; and a vehicle detection module configured to indicate the presence of a vehicle when the output of the receiver differs from the baseline by at least a predetermined amount and to indicate that no vehicles are present when the output of the receiver is within the predetermined amount of the baseline. The signature module is configured to, when the vehicle is present, record the output of the receiver over time as one of the first electronic vehicle signatures.

In further features, the signature module is configured to record, as the one of the first electronic vehicle signatures, the output of the receiver for up to a predetermined period after the vehicle detection module transitions from indicating that no vehicles are present to indicating that the vehicle is present.

In further features, the signature module is configured to stop recording the output of the receiver when the vehicle detection module transitions from indicating that the vehicle is present to indicating that no vehicles are present.

In further features, the signature module is configured to normalize the one of the first electronic vehicle signatures to a predetermined length.

In further features, the order manager module is configured to, on a display, visually display the selected one of the first food order and the second food order.

In further features, the order manager module is further configured to, in response to user input indicative of distribution of the first food order, delete the first food order and the first electronic vehicle signature.

In further features, a fourth vehicle detector is configured to capture fourth electronic vehicle signatures of vehicles at or approaching a third ordering terminal. The storage module is further configured to: store one of the fourth electronic vehicle signatures captured via the fourth vehicle detector before or during placement of a third food order via the third ordering terminal; and store the third food order in association with the one of the fourth electronic vehicle signatures. The signature comparison module configured to, in response to receipt of one of the third electronic vehicle signatures captured via the third vehicle detector: compare the one of the third electronic vehicle signatures with: (a) the stored one of the first electronic vehicle signatures; (b) the stored one of the second electronic vehicle signatures; and (c) the stored one of the fourth electronic vehicle signatures; and select the one of (a) the stored one of the first electronic vehicle signatures, (b) the stored one of the second electronic vehicle signatures, and (c) the stored one of the fourth electronic vehicle signatures that most closely matches the one of the third electronic vehicle signatures. The order manager module is configured to: selected the one of the first food order, the second food order, and the third food order that is associated with the selected one of (a) the stored one of the first electronic vehicle signatures, (b) the stored one of the second electronic vehicle signatures, and (c) the stored one of the fourth electronic vehicle signatures; and output the indicator of the selected one of the first food order, the second food order, and the third food order.

In a feature, an order management method includes: capturing first electronic vehicle signatures of vehicles at or approaching a first ordering terminal; capturing second electronic vehicle signatures of vehicles at or approaching a second ordering terminal; capturing third electronic vehicle signatures of vehicles at or approaching a drive-up window where food orders are distributed; storing one of the first electronic vehicle signatures captured via the first vehicle detector before or during placement of a first food order via the first ordering terminal; storing the first food order in association with the one of the first electronic vehicle signatures; storing one of the second electronic vehicle signatures captured via the second vehicle detector before or during placement of a second food order via the second ordering terminal; storing the second food order in association with the one of the second electronic vehicle signatures; in response to receipt of one of the third electronic vehicle signatures captured via the third vehicle detector: comparing the one of the third electronic vehicle signatures with: (a) the stored one of the first electronic vehicle signatures; and (b) the stored one of the second electronic vehicle signatures; and selecting the one of (a) the stored one of the first electronic vehicle signatures and (b) the stored one of the second electronic vehicle signatures that most closely matches the one of the third electronic vehicle signatures; selecting one of the first food order and the second food order that is associated with the selected one of (a) the stored one of the first electronic vehicle signatures and (b) the stored one of the second electronic vehicle signatures that most closely matches the one of the third electronic vehicle signatures; and outputting an indicator of the selected one of the first food order and the second food order.

In further features, the first, second, and third vehicle detectors include inductors.

In further features, the inductors are embedded below a driving surface over which vehicles drive.

In further features, the first, second, and third vehicle detectors include ultrasonic transceivers.

In further features, the first, second, and third vehicle detectors include infrared (IR) transceivers.

In further features, the order management method further includes: capturing a baseline of an output of a receiver of the first vehicle detector when zero vehicles are present within a predetermined distance of the first vehicle detector; indicating the presence of a vehicle when the output of the receiver differs from the baseline by at least a predetermined amount; indicating that no vehicles are present when the output of the receiver is within the predetermined amount of the baseline; and record the output of the receiver over time as one of the first electronic vehicle signatures.

In further features, recording the output of the receiver includes recording, as the one of the first electronic vehicle signatures, the output of the receiver for up to a predetermined period after the vehicle detection module transitions from indicating that no vehicles are present to indicating that the vehicle is present.

In further features, the order management method further includes stopping the recording of the output of the receiver when the vehicle detection module transitions from indicating that the vehicle is present to indicating that no vehicles are present.

In further features, the order management method further includes normalizing the one of the first electronic vehicle signatures to a predetermined length.

In further features, outputting an indicator includes, on a display, visually displaying the selected one of the first food order and the second food order.

In further features, the order management method further includes in response to user input indicative of distribution of the first food order, deleting the first food order and the first electronic vehicle signature.

In further features, the order management method further includes: capturing fourth electronic vehicle signatures of vehicles at or approaching a third ordering terminal; storing one of the fourth electronic vehicle signatures captured via the fourth vehicle detector before or during placement of a third food order via the third ordering terminal; and storing the third food order in association with the one of the fourth electronic vehicle signatures, where the comparing includes comparing the one of the third electronic vehicle signatures with: (a) the stored one of the first electronic vehicle signatures; (b) the stored one of the second electronic vehicle signatures; and (c) the stored one of the fourth electronic vehicle signatures, where the selecting includes selecting the one of (a) the stored one of the first electronic vehicle signatures, (b) the stored one of the second electronic vehicle signatures, and (c) the stored one of the fourth electronic vehicle signatures that most closely matches the one of the third electronic vehicle signatures, where the selecting includes selecting the one of the first food order, the second food order, and the third food order that is associated with the selected one of (a) the stored one of the first electronic vehicle signatures, (b) the stored one of the second electronic vehicle signatures, and (c) the stored one of the fourth electronic vehicle signatures, and where the outputting includes outputting the indicator of the selected one of the first food order, the second food order, and the third food order.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an illustration of an example integrated vehicle detection and order management system;

FIG. 2A includes an example implementation of vehicle detectors;

FIGS. 2B-2C include example implementations of one of the vehicle detectors;

FIG. 3 includes a functional block diagram including an example implementation of vehicle detectors and an order management system;

FIG. 4 includes a flowchart depicting an example method of capturing electronic signatures of vehicles at ordering stations;

FIG. 5 includes a flowchart depicting an example method of associating an electronic signature of a vehicle captured at or before an ordering station with a food order placed at the ordering station; and

FIG. 6 includes a flowchart depicting an example method of matching electronic vehicle signatures captured near a drive-up window with stored electronic vehicle signatures captured near ordering stations and, based on the electronic vehicle signatures, distributing food orders placed at the ordering stations to the proper vehicles.

In the drawings, reference numbers may be reused to identify similar and/or identical elements.

### DETAILED DESCRIPTION

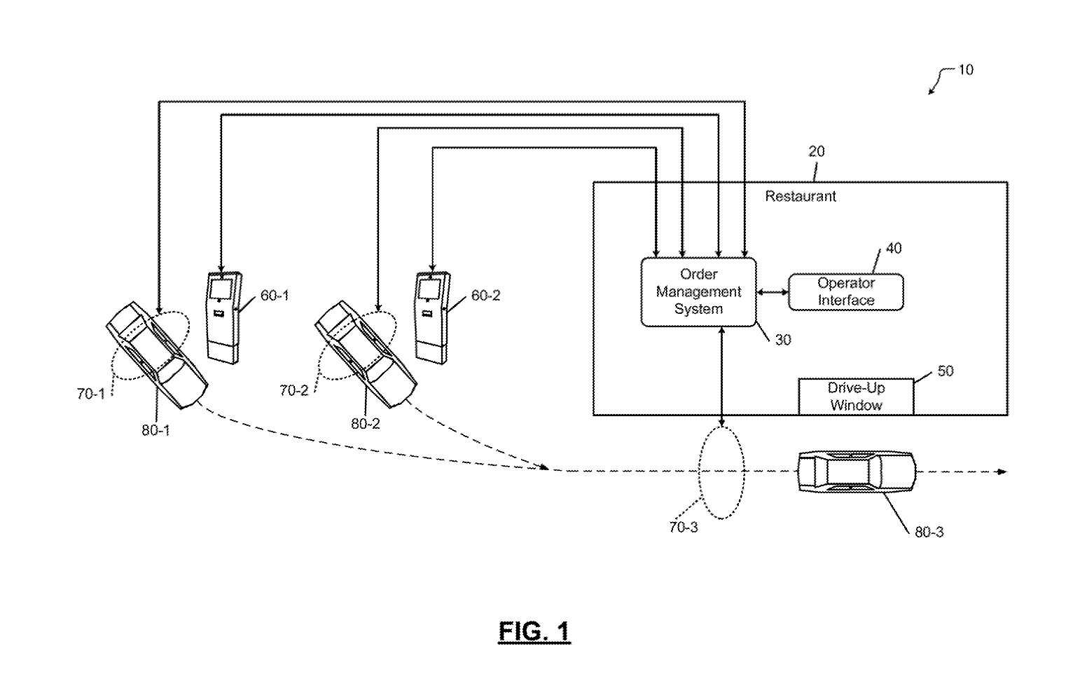

FIG. 1 illustrates an example integrated vehicle detection and order management system 10. The integrated vehicle-detecting order management system 10 includes a restaurant 20, an order management system 30, an operator interface 40, and a drive-up window 50.

The integrated vehicle detection and order management system 10 also includes a first (drive-through) ordering station 60-1 and a second (drive-through) ordering station 60-2 (collectively, ordering stations 60). The integrated vehicle detection and order management system 10 may also include a first vehicle detector 70-1, a second vehicle detector 70-2, and a third vehicle detector 70-3 (collectively, vehicle detectors 70). Although this example embodiment includes two ordering stations 60 and three vehicle detectors 70, a greater number of ordering stations 60 and vehicle detectors 70 may be implemented. For example, three ordering stations and four vehicle detectors may be implemented. Generally speaking, the number of vehicle detectors is greater than (e.g., by at least 1) than the number of ordering stations.

In the example of FIG. 1, the restaurant 20 (and the order management system 30) is in communication with the ordering stations 60. Operators of vehicles can place food orders at and via the ordering stations 60. For example, vehicle 80-1 is shown as placing an order at the first ordering station 60-1. Vehicle 80-2 is shown as placing an order at ordering station 60-2.

As an example, ordering stations 60 may include a microphone and speaker from which operators of vehicles 80-1, 80-2 and an employee of the restaurant 20 can communicate (e.g., verbally) to place food orders. The ordering stations 60 may also include a menu with available items from which a vehicle operator can select to place food orders. In response to receiving a food order, the employee may input the food order into the order management system 30 using the operator interface 40, such as a point of sale (POS) computing device. In addition to inputting orders, the employee may view previously placed orders using the operator interface 40.

As another example, ordering stations 60 may include self-order kiosks that are configured to directly receive food orders from vehicle operators. As an example, a vehicle operator may input a food order by selecting food items using user interfaces (e.g., a touchscreen displays) of the self-order kiosks. In response to receiving a food order, the self-order kiosks may transmit the food order to the order management system 30 wirelessly or by wire. In response to receiving a food order, self-order kiosks may request and process payment for food orders. Self-order kiosks may transmit food orders to the order management system 30 in response to receipt of payment for a food order. Payment may be made via a self-order kiosk, for example, in the form of cash, credit card, debit card, gift card, and/or one or more other suitable forms of payment.

After generating the food order, the operators of the vehicles 80-1, 80-2 drive their vehicles to the drive-up window 50, as shown by the dashed lines, in order to receive their food orders. For example, vehicle 80-3 previously placed a food order at one of the first and second ordering stations 60-1 and 60-2 and receives the food order at the drive-up window 50.

Which food order is associated with which vehicle, however, may be difficult to determine. The determination may be made more difficult, for example, by two or more food orders being placed at approximately the same time, by vehicle operators lingering at and/or departing from the ordering stations 60 for unpredictable amounts of time, etc.

According to the present disclosure, the order management system 30 is configured to capture electronic signatures of vehicles at the ordering stations 60 (e.g., as the vehicles approach the ordering stations 60) via the first and second vehicle detectors 70-1 and 70-2. The order management system 30 stores the captured electronic signatures of the vehicles with the placed food orders, respectively.

The order management system 30 also captures electronic signatures of vehicles at the drive-up window 50 (e.g., as the vehicles approach the drive-up window 50) via the third vehicle detector 70-3. The order management system 30 compares the electronic signature of a vehicle at the drive-up window 50 with the electronic signatures of vehicles of placed food orders that are to be distributed to determine which one of the placed food orders is associated with the vehicle at the drive-up window 50. More specifically, the one of the placed food orders that is associated with the stored electronic signature that most closely matches the electronic signature of the vehicle at the drive-up window 50 is identified. In this manner, the order management system 30 correlates the placed food orders with the vehicles approaching the drive-up window 50, respectively.

The order management system 30 identifies this one of the placed food orders (e.g., visually via the operator interface 40) for distribution to the vehicle at the drive-up window 50. The one of the placed food orders can then be properly distributed to the appropriate vehicle via the drive-up window. This prevents food orders from being improperly distributed to vehicles and increases throughput of the restaurant 20.

Once the food order has been distributed to the vehicle at the drive-up window 50, the food order and the stored electronic vehicle signature can be cleared or otherwise deleted from the order management system 30. This may limit the amount of data stored at any given time, decrease memory consumption of the order management system 30, increase accuracy of the order management system 30, and decrease computational effort (of the order management system 30) associated with correlating placed food orders with vehicles at the drive-up window 50.

As an example, the order management system 30 may receive a first food order from the first ordering station 60-1 and determine a first electronic signature of with vehicle 80-1 using the first vehicle detector 70-1. The order management system 30 stores the first food order and the first electronic signature in memory (e.g., a relational database) and associates the first food order and the first electronic signature.

The order management system 30 may also receive a second food order from the ordering station 60-2 and determine a second electronic signature of with vehicle 80-2 using the second vehicle detector 70-2. The order management system 30 stores the second food order and the second electronic signature in memory (e.g., the relational database) and associates the second food order and the second electronic signature.

When vehicle 80-1 approaches or arrives at the drive-up window 50, the order management system 30 determines a third electronic signature of vehicle 80-1 using the third vehicle detector 70-3. The order management system 30 compares the third electronic signature with the first and second electronic signatures. In this example, the order management system 30 determines that the third electronic signature most closely matches the first electronic signature because they were both of the vehicle 80-1. The order management system 30 may also compare the third electronic signature with other electronic signatures of other food orders to be distributed. In response to determining that the third electronic signature most closely matches the first electronic signature, the order management system 30 determines the one of the stored food orders that is associated with the first electronic signature. In this example, the first food order is associated with the first electronic signature.

The order management system 30 identifies the first food order (e.g., visually via the operator interface 40) for distribution to the vehicle at the drive-up window 50. Once assembled, the first food order can be properly distributed to vehicle 80-1 via the drive-up window 50.

When vehicle 80-2 approaches or arrives at the drive-up window 50, the order management system 30 determines a fourth electronic signature of vehicle 80-2 using the third vehicle detector 70-3. The order management system 30 compares the fourth electronic signature with the second electronic signature and determines that the fourth electronic signature most closely matches the signature electronic signature. The order management system 30 may also compare the fourth electronic signature with other electronic signatures of other food orders to be distributed. In response to determining that the fourth electronic signature most closely matches the second electronic signature, the order management system 30 determines the one of the stored food orders that is associated with the second electronic signature. In this example, the second food order is associated with the second electronic signature.

The order management system 30 identifies the second food order (e.g., visually via the operator interface 40) for distribution to the vehicle at the drive-up window 50. Once assembled, the second food order can be properly distributed to vehicle 80-2 via the drive-up window 50.

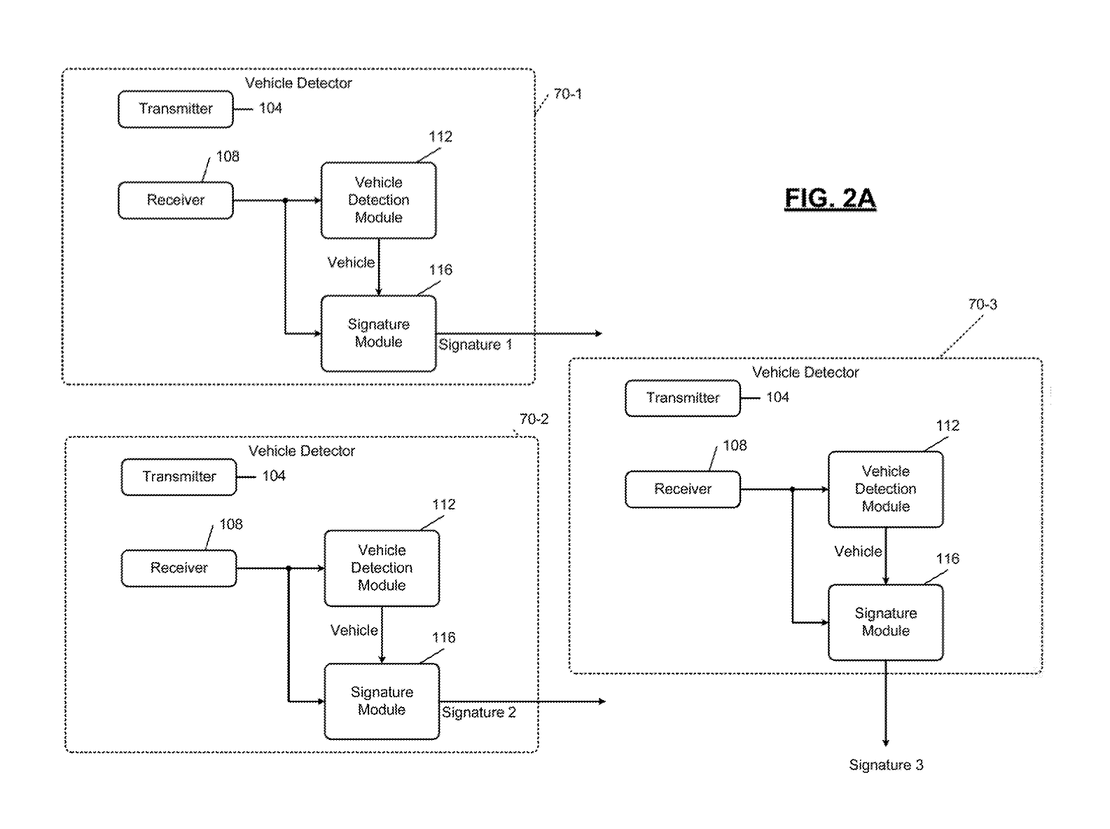

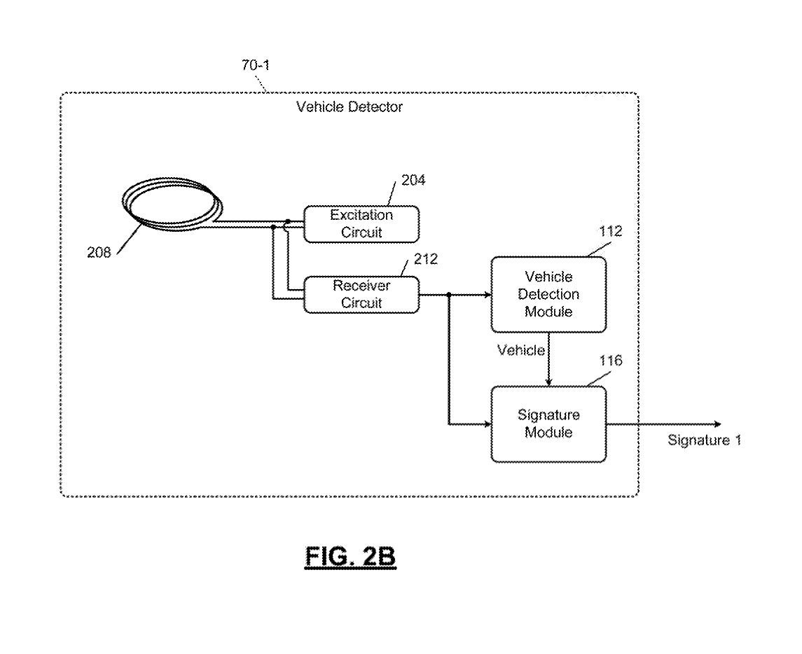

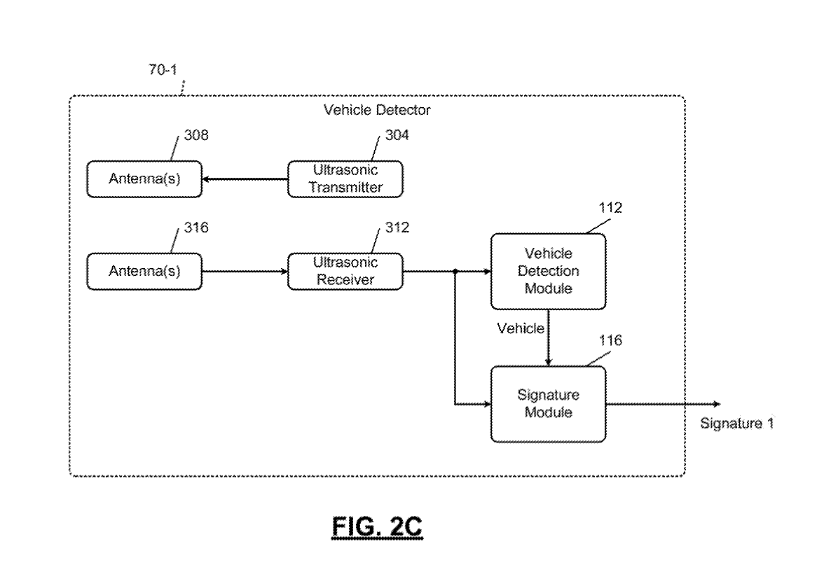

FIG. 2A includes an example implementation of the vehicle detectors 70. FIGS. 2B-2C include example implementations of one of the vehicle detectors 70.

The first vehicle detector 70-1 includes a transmitter 104, a receiver 108, a vehicle detection module 112, and a signature module 116. The example of the first vehicle detector 70-1 will be described in detail. However, the second and third vehicle detectors 70-2 and 70-3 may include the same or similar components and function the same or similarly.

The transmitter 104 wirelessly transmits signals within the predetermined area near the first ordering station 60-1, such as an area that vehicles pass through as vehicles approach the first ordering station 60-1. In the example of FIG. 2B, the transmitter 104 includes an excitation circuit 204 and a ground loop 208. The ground loop 208 may be, for example, an inductor coil. The ground loop 208 may be, for example, embedded within or located on top of a surface over which vehicles drive as vehicles approach the first ordering station 60-1.

The excitation circuit 204 may continuously apply a pulse-width modulation (PWM) signal of a predetermined frequency and a predetermined duty cycle to the ground loop 208. As a specific example, the excitation circuit 204 may be configured to provide a complete PWM signal nine times per second at a frequency between 1 kHz and 200 kHz. The excitation circuit 204 may include an oscillator, such as a Colpitts oscillator or a Hartley oscillator. The ground loop 208 generates a magnetic field when (electrical) power is applied to the ground loop 208.

In the example of FIG. 2C, the transmitter 104 includes an ultrasonic transmitter 304 and one or more antennas 308. The ultrasonic transmitter transmits ultrasonic signals within the predetermined area near the first ordering station 60-1 via the antenna(s) 308. For example, the ultrasonic transmitter 304 may transmit ultrasonic signals at sides or undercarriages of vehicles passing through the predetermined area. While the example of the ultrasonic transmitter 304 is provided, the present application is also applicable to other types of transmitters, such as sonar transmitters, a radar transmitters, radio frequency (RF) transmitters, infrared (IR) transmitters, and other types of wireless transmitters that transmit signals wirelessly via one or more antennas.

The receiver 108 receives signals from within the predetermined area near the first ordering station 60-1. Based on characteristics of the vehicle, the received signals change as vehicles pass through the predetermined area. The receiver 108 generates an output based on the received signals.

In the example of FIG. 2B, the receiver 108 includes a receiver circuit 212 that is connected to the ground loop 208 in parallel with the excitation circuit 204. A vehicle passing through the predetermined area alters the magnetic field generated by the ground loop 208. For example, electrically conductive (e.g., metal) components of the vehicle may induce an eddy current in the ground loop 208. As a result of the induced eddy current, the inductance of the ground loop 208 may decrease. The inductance decrease may cause an increase of a resonant frequency of the ground loop 208. The presence or absence of a vehicle within the predetermined area may be detected based on changes (e.g., increases) in the resonant frequency of the ground loop 208. The receiver circuit 212 may include a comparator op-amp that has an input coupled to the ground loop 208, and the comparator op-amp has an output that is coupled to a resistor. In response to the ground loop 208 receiving energy from the excitation circuit 204, the receiver circuit 212 is configured to generate a waveform corresponding to the resonant frequency of the corresponding ground loop 208. The waveform corresponding to the resonant frequency can be stored as an electronic signature of a vehicle. In various implementations, the receiver circuit 212 may be connected to another ground loop, such as another inductor coil.

In the example of FIG. 2C, the receiver 108 includes an ultrasonic receiver 312. A vehicle passing through the predetermined area near the first ordering station 60-1 reflects signals from the ultrasonic transmitter 304 back to the ultrasonic receiver 312. The ultrasonic receiver 312 receives the reflected signals via the antenna(s) 316. While the example of the ultrasonic receiver 312 is provided, the present application is also applicable to other types of receivers, such as sonar receivers, radar receivers, RF receivers, IR receivers, and other types of wireless receivers that receivers signals wirelessly via one or more antennas. The type of receiver implemented may be the same as the type of transmitter. A combination of a transmitter and a receiver may be referred to as a transceiver.

The vehicle detection module 112 detects the presence of a vehicle within the predetermined area near the first ordering station 60-1 based on the output of the receiver 108. For example, the vehicle detection module 112 may be calibrated with a baseline output of the receiver 108 captured when no vehicles are present within the predetermined area near the first ordering station 60-1. In the example of FIG. 2B, the ground loop 208 may have a baseline resonant frequency when no vehicle is located within the predetermined area. In the example of FIG. 2C, the ultrasonic receiver 312 may have a baseline output when no vehicle is located within the predetermined area.

When the output of the receiver 108 (e.g., voltage) deviates (e.g., becomes greater than or less than) the baseline by at least a predetermined amount, the vehicle detection module 112 may determine that a vehicle is present within the predetermined area. When the output of the receiver 108 is within the predetermined amount from the baseline, the vehicle detection module 112 may determine that no vehicles are present within the predetermined area. The predetermined amount may be greater than zero.

The vehicle detection module 112 generates a vehicle signal that indicates whether a vehicle is present within the predetermined area. For example, the vehicle detection module 112 may set the vehicle signal to a first state in response to determining that a vehicle is present within the predetermined area. The vehicle detection module 112 may set the vehicle signal to a second state in response to determining that no vehicles are present within the predetermined area.

When a vehicle is present within the predetermined area, the signature module 116 stores the output of the receiver 108. The stored output over time an electronic signature of the vehicle.

For example, the signature module 116 begins storing the output of the receiver 108 when the while signal transitions to the first state from the second state. The signature module 116 may continue to store the output of the receiver 108 while the vehicle signal remains in the first state. The signature module 116 may stop storing the output of the receiver 108 when the vehicle signal transitions from the first state to the second state.

In various implementations, the signature module 116 may store the output of the receiver 108 for up to a predetermined period beginning from when the vehicle signal transitions from the second state to the first state. For example, the signature module 116 may begin storing the output of the receiver 108 when the vehicle signal transitions from the second state to the first state and stop storing the output of the receiver 108 when the predetermined period has passed. In various implementations, the signature module 116 may stop storing the output of the receiver when the output of the receiver 108 remains unchanged for a predetermined period (e.g., 4 seconds). The output of the receiver 108 remaining unchanged may indicate that the vehicle has stopped moving. In various implementations, the signature module 116 may normalize the stored output, such as to have a predetermined length (e.g., period or number of values) by expanding or contracting the stored output.

The first, second, and third vehicle detectors 70-1, 70-2, and 70-3 transmit respective stored outputs to the order management system 30. In various implementations, the transmitter 104 and the receiver 108 of each of the vehicle detectors 70 may be located at the respective locations, and the vehicle detection modules and signature modules may be implemented within the order management system 30.

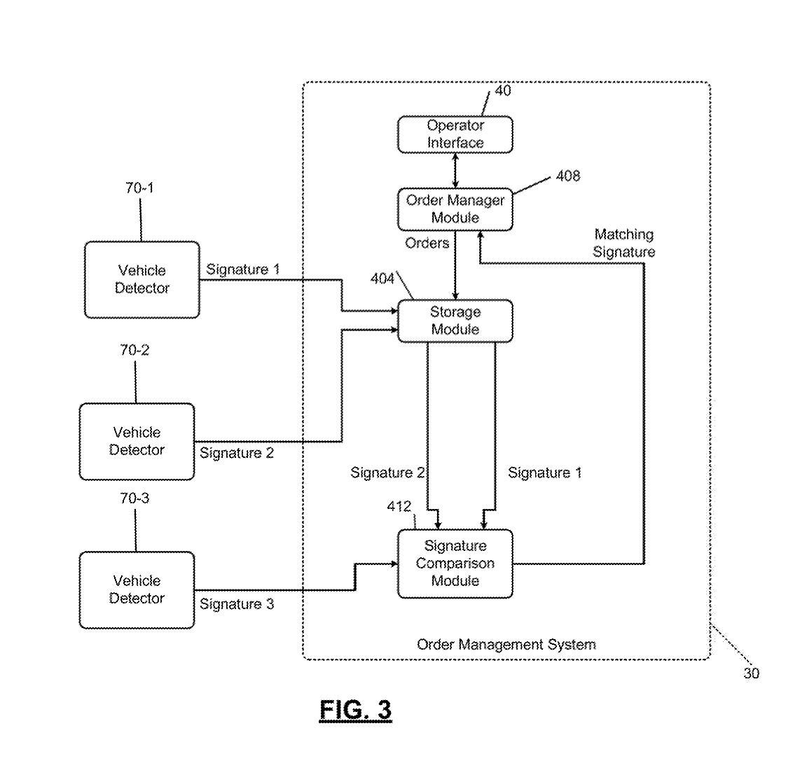

FIG. 3 includes a functional block diagram including the vehicle detectors 70 and the order management system 30. The order management system 30 may include a storage module 404, an order manager module 408, and a signature comparison module 412.

The storage module 404 receives the electronic vehicle signatures captured by the first and second vehicle detectors 70-1 and 70-2 of the ordering stations 60. The storage module 404 stores the electronic vehicle signatures in memory.

The order manager module 408 receives placed orders. The placed orders may be received, for example, via the operator interface 40 and/or the ordering stations 60 themselves (e.g., in the example of the ordering stations 60 including ordering kiosks). When an order is placed (e.g., indicated by receipt of a predetermined input), the storage module 404 stores the placed order in memory. The storage module 404 also associates the placed order from one of the ordering stations 60 with one of the stored electronic vehicle signatures from that one of the ordering stations 60. For example, when an order is placed using the first ordering station 60-1, the storage module 404 associates the placed order with the last electronic vehicle signature captured via the first ordering station 60-1. When an order is placed using the second ordering station 60-2, the storage module 404 associates the placed order with the last electronic vehicle signature captured via the second ordering station 60-2.

When the third vehicle detector 70-3 near the drive-up window 50 captures an electronic vehicle signature (“a pickup signature”), the signature comparison module 412 compares the pickup signature with the stored electronic vehicle signatures. For example, the signature comparison module 412 may compare the pickup signature with each of the electronic vehicle signatures that are stored in the memory at that time. Based on the comparisons, the signature comparison module 412 determines and indicates which one of the stored electronic vehicle signatures most closely matches the pickup signature. The signature comparison module 412 may determine which one of the stored electronic vehicle signatures most closely matches the pickup signature using a signal matching algorithm, such as a cross-correlation function.

The order manager module 408 receives the indication of the one of the stored electronic vehicle signatures that most closely matches the pickup signature. The order manager module 408 identifies the one of the placed orders stored in the memory that is associated with the one of the stored electronic vehicle signatures that most closely matches the pickup signature. The order manager module 408 outputs the one of the placed orders at the drive-up window 50, such as audibly (via a speaker) and/or visually (via a display, such as a display of the operator interface 40).

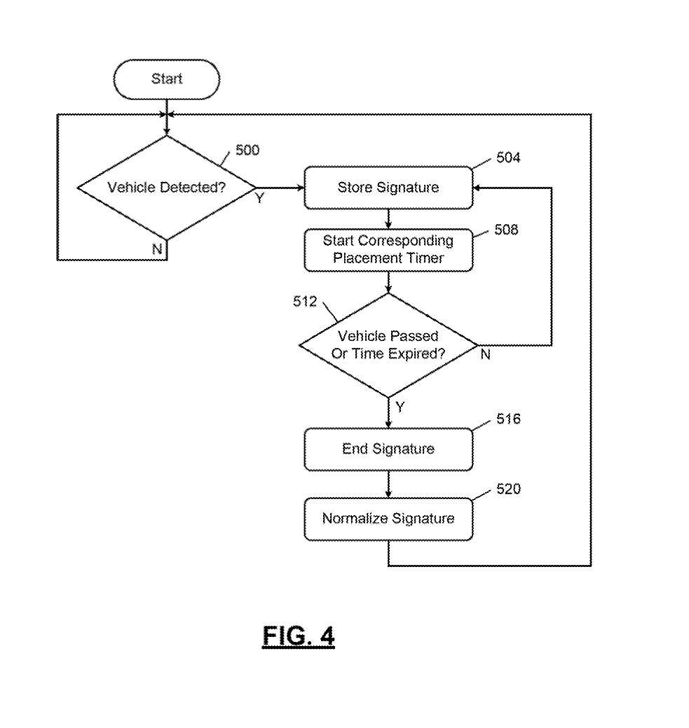

FIG. 4 is a flowchart depicting an example method of capturing electronic signatures of vehicles at ordering stations. While the example of the first vehicle detector 70-1 and the first ordering station 60-1 will be discussed, the following is also applicable to the second vehicle detector 70-2 and the second ordering station 60-2. The following is also applicable to one or more other vehicle detectors at one or more other ordering stations, respectively. The example of FIG. 4 may be performed concurrently at for each vehicle detector and ordering station.

Control begins with 500 where the vehicle detection module 112 determines whether the output of the receiver 108 has deviated from the baseline value by at least the predetermined amount. In other words, the vehicle detection module 112 may determine whether the output of the receiver 108 is greater than or less than the baseline value by at least the predetermined amount. The transmitter 104 generates output at the first vehicle detector 70-1, and the output of the receiver 108 is approximately the baseline value when no vehicle is present at the first vehicle detector 70-1. If 500 is true, control continues with 504. If 500 is false, control remains at 500.

At 504, the signature module 116 stores the output of the receiver 108. The stored values of the output of the receiver 108 form the electronic signature of the vehicle at the first vehicle detector 70-1. At 508, the signature module 116 may start a placement timer for the first ordering station 60-1. The signature module 116 may first reset the placement timer to zero. The placement timer may correspond to the period for the vehicle to place the order at the first ordering station 60-1.

At 512, vehicle detection module 112 may determine whether the output of the receiver 108 has returned to being within the predetermined amount of the baseline value. Additionally or alternatively, the vehicle detection module 112 may determine whether the placement timer is greater than a predetermined value or a predetermined period or whether the output of the receiver 108 has remained unchanged for a predetermined period. The output of the receiver 108 returning to within the predetermined amount of the baseline value indicates that the vehicle has left the first ordering terminal. If 512 is true, the signature module 116 stops storing the output of the receiver 108 at 516. Optionally, at 520 the signature module 116 may normalized the stored signature. The signature module 116 may, for example, expand or contract the stored signature to a predetermined length (e.g., a predetermined period or a predetermined number of data points). The expansion may be performed, for example, via interpolation between data points. Contraction may include, for example, trimming the stored signature to a predetermined number of data points. Control may return to 500 for a next vehicle at the first ordering station 60-1.

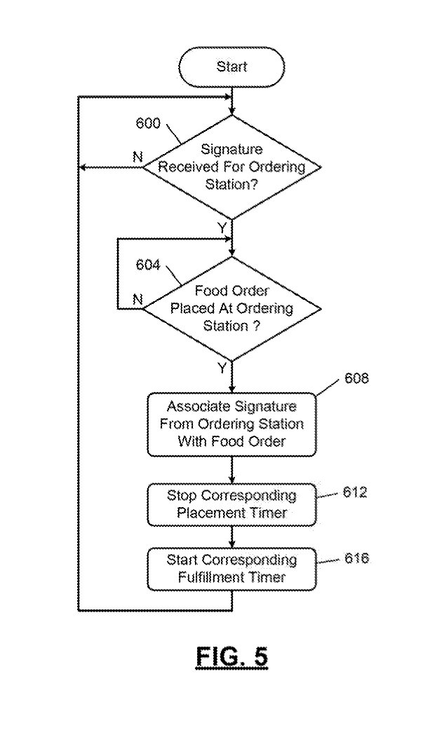

FIG. 5 is a flowchart depicting an example method of associating an electronic signature of a vehicle captured near an ordering station with a food order placed at the ordering station. While the example of the first vehicle detector 70-1 and the first ordering station 60-1 will be discussed, the following is also applicable to the second vehicle detector 70-2 and the second ordering station 60-2. The following is also applicable to one or more other vehicle detectors at one or more other ordering stations, respectively. The example of FIG. 5 may be performed concurrently at for each vehicle detector and ordering station.

Control begins with 600 where the storage module 404 determines whether an electronic vehicle signature has been received from the first ordering station 60-1. If 600 is true, the storage module 404 stores the electronic vehicle signature in memory and control continues with 604. If 600 is false, control may remain at 600.

At 604, the storage module 404 determines whether a food order has been placed at the first ordering station 60-1. If 604 is true, control continues with 608. If 604 is false, control may remain at 604. The storage module 404 may delete the electronic vehicle signature if a food order is not placed at the first ordering station 60-1 within a predetermined period of the receipt of the electronic vehicle signature or another electronic vehicle signature is received before a food order is placed at the first ordering station 60-1.

At 608, the storage module 404 creates an association between the electronic vehicle signature and the placed food order in the memory. At 612, the order manager module 408 may stop the placement timer. The placement timer may therefore indicate how long it took for the vehicle to place the order at the first ordering station 60-1. Values of the placement timer may be used for various reasons. At 616, the order manager module 408 may start a fulfillment timer for the placed order. The signature module 116 may first reset the fulfillment timer to zero. The fulfillment timer may correspond to the period for prepare and deliver the placed order to the specific vehicle that placed the food order at the first ordering station 60-1. Control may return to 600 for a next food order.

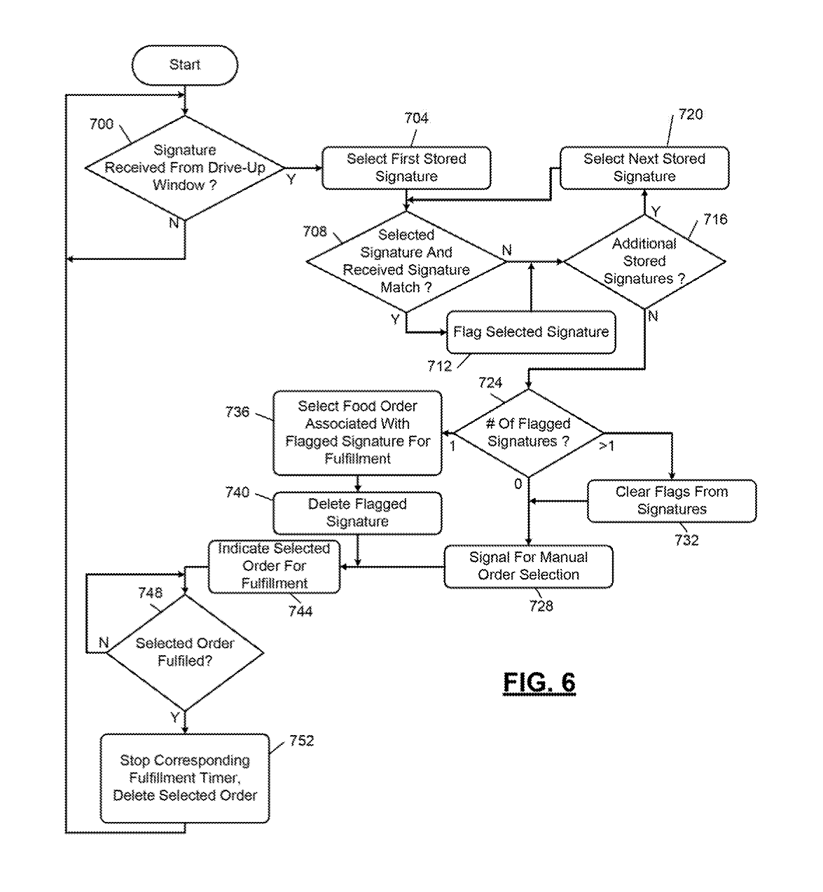

FIG. 6 is a flowchart depicting an example method of matching electronic vehicle signatures captured near a drive-up window with stored electronic vehicle signatures captured near ordering stations and, based on the electronic vehicle signatures, distributing food orders placed at the ordering stations to the proper vehicles.

Control begins with 700 where the signature comparison module 412 determines whether an electronic vehicle signature (“pickup signature”) has been received from the third vehicle detector 70-3 located near the drive-up window 50. If 700 is true, control continues with 704. If 700 is false, control may remain at 700.

At 704, the signature comparison module 412 may select a first electronic vehicle signature stored in the memory. One food order is associated with each of the electronic vehicle signatures stored in the memory.

At 708, the signature comparison module 412 compares the pickup signature captured using the third vehicle detector 70-3 with the selected one of the stored electronic vehicle signatures (captured using the first or second vehicle detector 70-1 or 70-2) and determines a level of matching between the pickup signature and the selected one of the stored electronic vehicle signatures. The signature module 116 may also determine whether the pickup signature matches the selected one of the stored electronic vehicle signatures at 708. For example, the signature comparison module 412 may determine whether a matching value generated based on the comparison is greater than a predetermined value. The signature comparison module 412 may increase the matching value as closeness between the selected one of the stored electronic vehicle signatures and the pickup signature increases and vice versa. If 708 is true, the signature comparison module 412 may flag the selected one of the stored electronic vehicle signatures at 712, and control may continue with 716. If 708 is false, the signature comparison module 412 may not flag the selected one of the stored electronic vehicle signatures and control may continue with 716.

At 716, the signature comparison module 412 determines whether one or more electronic vehicle signatures are stored in the memory that have not yet been compared with the pickup signature. If 716 is true, the signature comparison module 412 selects another one of the electronic vehicle signatures and control continues with 708. If 716 is false, control continues with 724.

At 724, the signature comparison module 412 determines whether zero (0), one (1), or more than one (>1) of the stored electronic vehicle signatures have been flagged at 712 as matching the pickup signature. If zero of the stored electronic vehicle signatures have been flagged, control continues with 728, and the order manager module 408 outputs an indication for an employee of the restaurant to correlate the vehicle at the drive-up window 50 with one of the placed food orders. The indication may be audible and/or visual. The order manager module 408 deletes the selected one of the stored electronic vehicle signatures after selection by the employee. If more than one of the stored electronic vehicle signatures have been flagged, the signature comparison module 412 clears the flags at 732, and proceeds with 728. The order manager module 408 outputs an indication for an employee of the restaurant to (manually) correlate the vehicle at the drive-up window 50 with one of the placed food orders. The indication may be audible and/or visual. The order manager module 408 deletes the selected one of the stored electronic vehicle signatures after selection by the employee. If only one of the stored electronic vehicle signatures have been flagged, control continues with 736. At 736, the signature comparison module 412 selects the one of the stored electronic vehicle signatures, and the order manager module 408 selects the one of the food orders that is associated with the selected one of the stored electronic vehicle signatures. At 740, the order manager module 408 may delete the selected one of the stored vehicle signatures from the memory.

At 744, the order manager module 408 outputs an indication for an employee of the restaurant indicative of the selected one of the food orders for fulfillment via delivery of the selected one of the food orders to the vehicle at the drive-up window 50. The indication may be audible and/or visual.

At 748, the order manager module 408 may determine whether the selected one of the food orders has been fulfilled. The order manager module 408 may determine that the selected one of the food orders has been fulfilled, for example, in response to receipt of a predetermined user input indicative of food order fulfillment. If 748 is true, control continues with 752. If 748 is false, control may remain at 748. At 752, the order manager module 408 stops the fulfillment timer for the food order and deletes the selected one of the food orders from memory. Control may return to 700 for fulfillment of a food order for a next vehicle to reach the drive-up window 50.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An order management system, comprising:
a first vehicle detector configured to capture first electronic vehicle signatures of vehicles at or approaching a first ordering terminal;
a second vehicle detector configured to capture second electronic vehicle signatures of vehicles at or approaching a second ordering terminal;
a third vehicle detector configured to capture third electronic vehicle signatures of vehicles at or approaching a drive-up window where food orders are distributed to vehicles;
a storage module configured to:
store one of the first electronic vehicle signatures captured via the first vehicle detector before or during placement of a first food order via the first ordering terminal;
store the first food order in association with the one of the first electronic vehicle signatures;
store one of the second electronic vehicle signatures captured via the second vehicle detector before or during placement of a second food order via the second ordering terminal;
store the second food order in association with the one of the second electronic vehicle signatures;
a signature comparison module configured to, in response to receipt of one of the third electronic vehicle signatures captured via the third vehicle detector:
compare the one of the third electronic vehicle signatures with:
(a) the stored one of the first electronic vehicle signatures; and
(b) the stored one of the second electronic vehicle signatures; and
select the one of (a) the stored one of the first electronic vehicle signatures and (b) the stored one of the second electronic vehicle signatures that most closely matches the one of the third electronic vehicle signatures; and
an order manager module configured to:
selected one of the first food order and the second food order that is associated with the selected one of (a) the stored one of the first electronic vehicle signatures and (b) the stored one of the second electronic vehicle signatures that most closely matches the one of the third electronic vehicle signatures; and
display, on a display, the selected one of the first food order and the second food order.

2. The order management system of claim 1 wherein the first, second, and third vehicle detectors include inductors.

3. The order management system of claim 2 wherein the inductors are embedded below a driving surface over which vehicles drive.

4. The order management system of claim 1 wherein the first, second, and third vehicle detectors include ultrasonic transceivers.

5. The order management system of claim 1 wherein the first, second, and third vehicle detectors include infrared (IR) transceivers.

6. The order management system of claim 1 wherein the first vehicle detector includes:
a receiver;
a signature module configured to capture a baseline of an output of the receiver when zero vehicles are present within a predetermined distance of the first vehicle detector; and
a vehicle detection module configured to indicate the presence of a vehicle when the output of the receiver differs from the baseline by at least a predetermined amount and to indicate that no vehicles are present when the output of the receiver is within the predetermined amount of the baseline,
wherein the signature module is configured to, when the vehicle is present, record the output of the receiver over time as one of the first electronic vehicle signatures.

7. The order management system of claim 6 wherein the signature module is configured to record, as the one of the first electronic vehicle signatures, the output of the receiver for up to a predetermined period after the vehicle detection module transitions from indicating that no vehicles are present to indicating that the vehicle is present.

8. The order management system of claim 6 wherein the signature module is configured to stop recording the output of the receiver when the vehicle detection module transitions from indicating that the vehicle is present to indicating that no vehicles are present.

9. The order management system of claim 6 wherein the signature module is configured to normalize the one of the first electronic vehicle signatures to a predetermined length.

10. The order management system of claim 1 wherein the order manager module is configured to, on a display, visually display the selected one of the first food order and the second food order.

11. The order management system of claim 1 wherein the order manager module is further configured to, in response to user input indicative of distribution of the first food order, delete the first food order and the first electronic vehicle signature.

12. The order management system of claim 1 further comprising:
a fourth vehicle detector configured to capture fourth electronic vehicle signatures of vehicles at or approaching a third ordering terminal,
wherein the storage module is further configured to:
store one of the fourth electronic vehicle signatures captured via the fourth vehicle detector before or during placement of a third food order via the third ordering terminal; and
store the third food order in association with the one of the fourth electronic vehicle signatures,
wherein the signature comparison module configured to, in response to receipt of one of the third electronic vehicle signatures captured via the third vehicle detector:
compare the one of the third electronic vehicle signatures with:
(a) the stored one of the first electronic vehicle signatures;
(b) the stored one of the second electronic vehicle signatures; and
(c) the stored one of the fourth electronic vehicle signatures; and
select the one of (a) the stored one of the first electronic vehicle signatures, (b) the stored one of the second electronic vehicle signatures, and (c) the stored one of the fourth electronic vehicle signatures that most closely matches the one of the third electronic vehicle signatures, and
wherein the order manager module is configured to:
selected the one of the first food order, the second food order, and the third food order that is associated with the selected one of (a) the stored one of the first electronic vehicle signatures, (b) the stored one of the second electronic vehicle signatures, and (c) the stored one of the fourth electronic vehicle signatures; and
output the indicator of the selected one of the first food order, the second food order, and the third food order.

13. An order management method, comprising:
capturing first electronic vehicle signatures of vehicles at or approaching a first ordering terminal;
capturing second electronic vehicle signatures of vehicles at or approaching a second ordering terminal;
capturing third electronic vehicle signatures of vehicles at or approaching a drive-up window where food orders are distributed;
storing one of the first electronic vehicle signatures captured via the first vehicle detector before or during placement of a first food order via the first ordering terminal;
storing the first food order in association with the one of the first electronic vehicle signatures;
storing one of the second electronic vehicle signatures captured via the second vehicle detector before or during placement of a second food order via the second ordering terminal;
storing the second food order in association with the one of the second electronic vehicle signatures;
in response to receipt of one of the third electronic vehicle signatures captured via the third vehicle detector:
comparing the one of the third electronic vehicle signatures with:
(a) the stored one of the first electronic vehicle signatures; and
(b) the stored one of the second electronic vehicle signatures; and
selecting the one of (a) the stored one of the first electronic vehicle signatures and (b) the stored one of the second electronic vehicle signatures that most closely matches the one of the third electronic vehicle signatures;
selecting one of the first food order and the second food order that is associated with the selected one of (a) the stored one of the first electronic vehicle signatures and (b) the stored one of the second electronic vehicle signatures that most closely matches the one of the third electronic vehicle signatures; and
outputting an indicator of the selected one of the first food order and the second food order.

14. The order management method of claim 13 wherein the first, second, and third vehicle detectors include inductors.

15. The order management method of claim 14 wherein the inductors are embedded below a driving surface over which vehicles drive.

16. The order management method of claim 13 wherein the first, second, and third vehicle detectors include ultrasonic transceivers.

17. The order management method of claim 13 wherein the first, second, and third vehicle detectors include infrared (IR) transceivers.

18. The order management method of claim 13 further comprising:
capturing a baseline of an output of a receiver of the first vehicle detector when zero vehicles are present within a predetermined distance of the first vehicle detector;
indicating the presence of a vehicle when the output of the receiver differs from the baseline by at least a predetermined amount;
indicating that no vehicles are present when the output of the receiver is within the predetermined amount of the baseline; and
record the output of the receiver over time as one of the first electronic vehicle signatures.

19. The order management method of claim 18 wherein record the output of the receiver includes recording, as the one of the first electronic vehicle signatures, the output of the receiver for up to a predetermined period after the vehicle detection module transitions from indicating that no vehicles are present to indicating that the vehicle is present.

20. The order management method of claim 18 further comprising stopping the recording of the output of the receiver when the vehicle detection module transitions from indicating that the vehicle is present to indicating that no vehicles are present.

21. The order management method of claim 18 further comprising normalizing the one of the first electronic vehicle signatures to a predetermined length.

22. The order management method of claim 13 wherein outputting an indicator includes, on a display, visually displaying the selected one of the first food order and the second food order.

23. The order management method of claim 13 further comprising, in response to user input indicative of distribution of the first food order, deleting the first food order and the first electronic vehicle signature.

24. The order management method of claim 13 further comprising:
capturing fourth electronic vehicle signatures of vehicles at or approaching a third ordering terminal;
storing one of the fourth electronic vehicle signatures captured via the fourth vehicle detector before or during placement of a third food order via the third ordering terminal; and
storing the third food order in association with the one of the fourth electronic vehicle signatures,
wherein the comparing includes comparing the one of the third electronic vehicle signatures with:
(a) the stored one of the first electronic vehicle signatures;
(b) the stored one of the second electronic vehicle signatures; and
(c) the stored one of the fourth electronic vehicle signatures;
wherein the selecting includes selecting the one of (a) the stored one of the first electronic vehicle signatures, (b) the stored one of the second electronic vehicle signatures, and (c) the stored one of the fourth electronic vehicle signatures that most closely matches the one of the third electronic vehicle signatures,
wherein the selecting includes selecting the one of the first food order, the second food order, and the third food order that is associated with the selected one of (a) the stored one of the first electronic vehicle signatures, (b) the stored one of the second electronic vehicle signatures, and (c) the stored one of the fourth electronic vehicle signatures, and
wherein the outputting includes outputting the indicator of the selected one of the first food order, the second food order, and the third food order.
